(19) United States
(12) Patent Application Publication
(10) Pub. No.: US 2008/0229914 A1
(43) Pub. Date: Sep. 25, 2008

(54) Foot operated transport controller for digital audio workstations

(76) Inventor: Trevor Nathanial, Los Angeles, CA (US)

Correspondence Address: EDWIN TARVER, 16830 Ventura Blvd., SUITE 360, Encino, CA, 91436, US

(21) Appl. No.: 11/725,302

(22) Filed: Mar. 19, 2007

(51) Int. Cl. G10H 1/32

(52) U.S. Cl. 84/644

(57) ABSTRACT

A foot-operated programmable transport controller for use in conjunction with a sound and music-editing software application while connecting a musical instrument. The controller comprises a keyboard comprising a plurality of keys; each key for performing at least one function pertaining to the software application. The controller further comprises a user interface for creating, editing, storing, and retrieving different profiles; the profile being a complete set of all functions assigned to all the keys and their combinations. The user interface is provided through a host computer system.

### CROSS-REFERENCE TO RELATED APPLICATION

None

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates in general to foot operated device for digital audio workstation, and more particularly to foot operated transport controller used in interface with the music editing software applications for sound and music editing.

A variety of foot operated device for digital workstations have been developed in art. U.S. Pat. No. 4,046,049 to Luce discloses an electronic synthesizer instrument incorporating bass pedals for the notes of the musical scale, together with foot control apparatus adapted to select and modify the tone quality of sounds produced by operation of the bass pedals. The foot control apparatus comprises push button switches which are operated by the toe of an operator's foot, and slide controls which are positioned by the operator's foot. At least some of the switches are preset switches for selecting and controlling multiple combinations of the functional units of the synthesizer. The control state of the instrument is at all times indicated by readily observable indicating lights.

U.S. Pat. No. 4,316,401 to Tavel discloses a music synthesizer which responds to a music note played by a music instrument. The synthesizer has an envelope generator which generates a control signal in relation to the input signal to control the loudness of the synthesized note. The programmed note is that note following the operation of a control switch. The synthesizer further includes a series of footpads which control various functions of the synthesizer, such as programming the programmed note, and to allow the user to control the synthesized sound while playing an instrument. The synthesizer also comprises a timbral image modulator which can be selected to provide one of eight different waveshapes to control the cutoff frequency of a voltage controlled filter. The synthesized sound is obtained by amplifying the filter output signal by a gain determined by the envelope generator signal. However, both the above disclosed devices control the sound output from a synthesizer and also do not have a computerized means of control.

U.S. Pat. No. 6,689,947 to Ludwig discloses a floor controller for real-time control of signal processors, synthesizers, musical instruments, MIDI processors, lighting, and video, special effects in performance, recording, and composition environments. Various combinations of physical controllers may be utilized, as well as visual displays and internal control processing. Each physical controller may include a separate visual display of assigned name, status, and/or value. Rocking foot pedals may be used to simultaneously control multiple parameters by inclusion of additional sensors. Each physical controller may be assigned specific control message functions, values, names, temporal event sequences, and invocation rules dictated by assignable state-machines. Physical controllers and assignments may be organized in hierarchical or other relationships rich in geometric metaphors useful for human operation. The control system accommodates MIDI and non-MIDI control signal implementations. However, the above device cannot be interfaced with a computer system.

Therefore, it is an object of the present invention to provide a transport controller device compatible with all the sound and music editing software available in market. These and other objects of the present invention will become better understood with reference to the appended Summary, Description, and Claims.

### SUMMARY

The present invention is a battery-powered, foot-operated programmable keyboard connected to a computer system via a wireless USB connection. The keyboard assists a user in performing sound and music editing work when using sound and music-editing software applications. The keyboard interfaces with various sound and music-editing software applications such as Digital Performer, Pro Tools, Logic, Cubase, and Wave Lab. The controller of the present invention combines firmware and software in an electrical and mechanical design. The invention enables the user to operate controls by foot thus freeing the hands to play an instrument, direct others by hand or operate other controls.

The keyboard comprises a plurality of momentary-contact keys or footpads numbered ‘1’ through ‘8’. The key numbered ‘8’ acts as a function key. The function key is operated in conjunction with any of the other seven keys. Each key numbered ‘1’ through ‘7’ can perform functions by three key press events, namely, single press, double press, and function press. The single press event involves pressing the key once and double press event involves pressing the key twice in succession. A function press involves pressing the function key followed by any one of the remaining seven keys.

The keyboard further comprises a user interface on the host computer, which changes the settings and functions of the keys. A single set of all functions represented by every type of key press event, involving all of the keys, is called a profile. Users can create new profiles or modify existing profiles and save them on the host computer system. Default profiles complying with popular sound and music editing software applications are provided on a secondary storage device, such as a CD.

### BRIEF DESCRIPTION OF THE FIGURES

FIG. 1 is an illustration of the perspective view of the foot-operated keyboard in accordance with present invention.

FIG. 2 is a table showing the default functions of the keys of the keyboard.

FIG. 3 is an illustration of the main utility window displaying the default functions of FIG. 2.

FIG. 4 is an illustration of the key function/definition editor window displaying the default functions of a first key cap link.

### FIGURES—REFERENCE NUMERALS

10 . . . Keyboard
12 . . . Key or Footpad
14 . . . Main Utility Window
16 . . . Key Function/Definition Editor Window
18 . . . Key Cap Link
20 . . . Functional Name Field
22 . . . ‘Double Press’ Button
24 . . . ‘Function Press’ Button
26 . . . ‘Read’ Button
28 . . . ‘Write’ Button
30 . . . Current Profile Path Display
32 . . . ‘Open’ Button
34 . . . ‘Save’ Button
36 . . . Double Press Adjustment Feature
38 . . . Minimize Button
40 . . . Help Button
42 . . . Close Button
44 . . . Key Definition String Field
46 . . . Key Number Field
48 . . . ‘Capture’ Button
50 . . . ‘Cancel & Close’ Button
52 . . . ‘Save & Close’ Button
54 . . . Display
56 . . . LED Monitor

### DETAILED DESCRIPTION

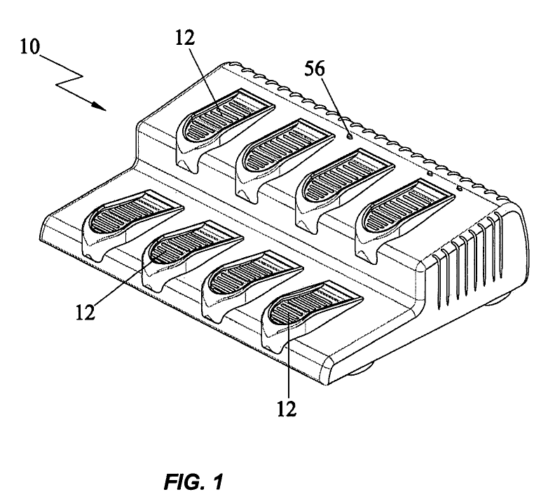

The novel features of the present invention will become apparent from the following description of a preferred embodiment of the invention and as illustrated in FIGS. 1 through 4. The present invention is a battery-powered, foot-operated programmable keyboard 10 connected to a computer system. The keyboard 10 is designed to assist musicians, sound engineers, or other audio-editing operators in editing digital sound and music works in sound and music-editing software applications by freeing their hands and controlling essential keyboard functions by foot. The keyboard 10 complies with various sound and music-editing software applications such as Digital Performer, Pro Tools, Logic, Cubase, Wave Lab, among others. The keyboard 10 provides a user interface on the host computer system for configuring settings such as assigning a function to each key 12, enabling and disabling key functions 12, storing and retrieving the configurations to and from disk storage, and performing other types of configurations.

The keyboard 10 is similar to a stepped structure with two steps. Each step comprises four momentary-contact footpads or keys 12 spaced apart from each other. The keys 12 are ergonomically designed to provide convenient foot-placement in order to press them. The keyboard 10 is connected to the computer through a wireless Universal Serial Bus (USB) connection. The keyboard 10 also comprises a printed circuit board, batteries, and a wireless USB adapter that can be plugged into an available USB port on the host computer system. The printed circuit board comprises a processor, a non-volatile memory, and a programmable firmware memory. The keyboard 10 further comprises features such as an automatic low-power standby mode, a low battery Light Emitting Diode (LED) indicator, a low wireless signal strength LED indicator, and an activity LED monitor 56 that activates when any key 12 is pressed.

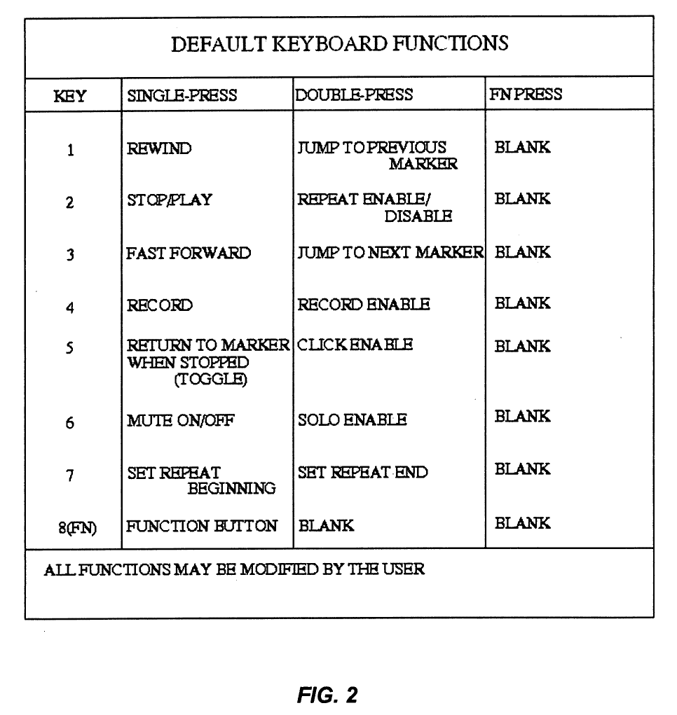

The keys 12 on the keyboard 10 are numbered ‘1’ through ‘8’. The key 12 numbered ‘8’ may optionally be designated as a function key 12. The keys 12 numbered ‘1’ through ‘7’ respond to three types of events, each of which represents a unique function. The three types of events are: a single press, a double press, and a function press. The single press event relates to pressing a key 12 once, double press events relate to pressing a key 12 twice in succession, and function press events relate to pressing the function key 12 first followed by any other key 12 numbered ‘1’ through ‘7’. The function key 12 per se does not represent any function, and must always be coupled with one of the other seven keys 12 to make it functional. However, an option is provided so that the function key 12 can respond to single and double press actions. All the functions that are represented by each type of event can be programmed or modified through the user interface provided by the keyboard 10 on the host computer system. The default functions of the keys 12 are discussed in detail in FIG. 2. Each event programmed by the user transmits a keystroke or macro string of keystrokes to the host computer system.

The keyboard 10 further comprises a collection of profiles on a secondary storage device, such as a CD or a DVD, as a supplement. Each profile is programmed to meet the needs of users operating a variety of popular sound and music editing software applications. A profile comprises of the entire collection of all the functions represented by all the events of all the keys 12 and all the corresponding settings of the keyboard 10. Profiles can also be modified and stored in the host computer system. Thereafter, any of the modified and stored profiles can be retrieved from the host computer system and can be loaded into the keyboard 10. When a new profile is loaded into the keyboard 10, the existing profile in the keyboard 10 will be over written by the new profile changing all the functions and settings of the keyboard 10 in accordance with the settings and the functions defined by the new profile.

The user interface is used for creating new profiles, modifying existing profiles, and profile storage and retrieval. The user interface comprises of a series of controls operated on a computer through a main utility window 14. The keyboard 10 can be operated while the main utility window 14 is inactive or closed. Typically, a user will only need to launch the main utility window 14 in order to view it, make changes to a profile, or to create new profiles.

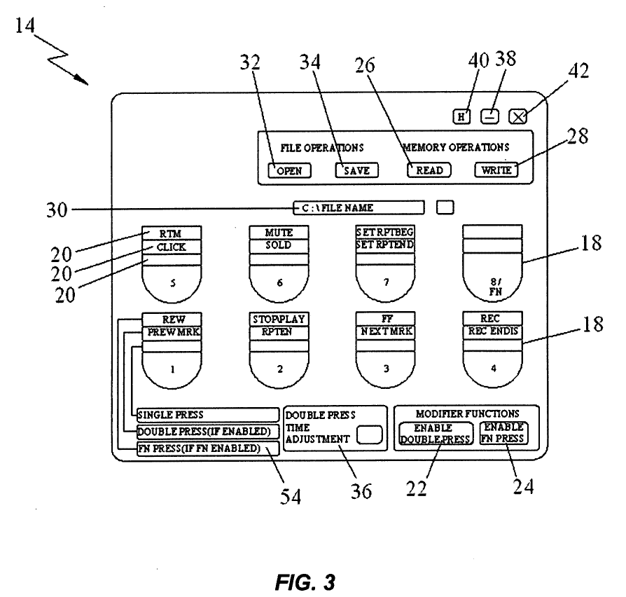

FIG. 3 illustrates the features of the main utility window 14 of the present invention. Initially when the main utility window 14 is launched, a program runs a checkup in order to identify the presence of the keyboard 10. If the checkup fails to identify the keyboard 10, a message is displayed indicating that the keyboard 10 cannot be identified and prompts the user to click ‘OK’ thus ending the main utility window program. When the keyboard 10 is identified, the program allows the user to operate the main utility window 14.

The main utility window 14 comprises eight key cap links 18 numbered ‘1’ through ‘8’ analogous to the footpads or keys 12 numbered ‘1’ through ‘8’ on the keyboard 10. Each key cap link 18 numbered ‘1’ through 7 comprises three functional name fields 20. The three functional name fields 20 of a particular key cap link 18 displays the three functions performed by its corresponding key 12 on the keyboard 10, each function resulting from each type of event. The first, second, and third functional fields represent the single press, double press, and function press events, respectively. Each function displayed in the functional name field 20 of any key 12 relates to an underlying character string. The functional name field 20 of anyone of the eight key cap links 18 when clicked upon takes the user to a key function editor window 16 of the corresponding key cap link 18. The user can edit the names of the functions and their underlying character strings in the key function editor window 16.

The main utility window comprises a plurality of function modifier buttons, namely, an ‘enable double-press’ button 22 and an ‘enable function-press’ button 24. The activation of the ‘enable double-press’ button 22 causes all the functions represented by the double press events of all the keys 12 become active. When the ‘enable double-press’ button 22 is deactivated, all the functions represented by the double press events of all the keys 12 become inactive. In other words, when the ‘enable double-press’ button 22 is inactive, double press of a key 12 on the keyboard 10 does not produce any functional effect. Similarly, when the ‘enable function-press’ button 24 is activated, all the functions represented by the function press events of all the keys 12 become active and vice versa.

The key 12 ‘8’ or the function key 12 can be made to respond to the single or double press event when the ‘enable function-press’ button 24 is activated. The function key cap link 18 comprises two functional name fields 20 instead of three. The two functional name fields display functions performed by the single and double press event. Each function displayed in the functional name field 20 of the function key cap link 18 has to be assigned by the user.

The main utility window 14 comprises a plurality of memory operation buttons, namely a ‘read’ button 26 and a ‘write’ button 28. The clicking of ‘read’ button 26 causes the profile stored in the keyboard 10 is loaded into the currently displayed profile, being used by the user. If the currently displayed profile has been modified and not saved, and when the user clicks on the ‘read’ button 26, the program prompts the user to save the changes or the modifications before loading the profile, which is stored in the keyboard 10. When the user clicks the ‘write’ button 28, the currently displayed profile overwrites the profile stored in the keyboard 10.

The main utility window 14 comprises a current profile path display means 30 for displaying the current profile path and file name stored in the host computer system. The main utility window 14 further comprises a plurality of file operation buttons, namely, an ‘open’ button 32 and a ‘save’ button 34. The profiles already saved in the host computer system may be retrieved and loaded into the keyboard 10 by clicking on the ‘open’ button 32. A new or modified profile can be saved in the host computer system by clicking on the ‘save’ button 34.

The main utility window 14 further comprises a ‘legend’ display 54, and a double press adjustment feature 36. The display 54 describes the key functions related to the single press, double press, and the function press events. The double press adjustment feature 36 enables the user to adjust timing of the double press event. The main utility window 14 also comprises a plurality of window control operations comprising a ‘minimize’ button 38, a ‘help’ button 40, and a ‘close’ button 42 located on top of the window 14. The ‘minimize’ button 38 minimizes or hides the main utility window 14 without closing the application. To restore the minimized window 14, the user has to click on its corresponding icon on a task bar. The ‘help’ button 40 launches the help window when clicked. The ‘close’ button 42 is used to close the main utility window 14, thereby closing the application. If the user made changes to the currently displayed profile and clicks on the ‘close’ button 42 without saving the changes, the program prompts the user to choose whether to save the profile or not.

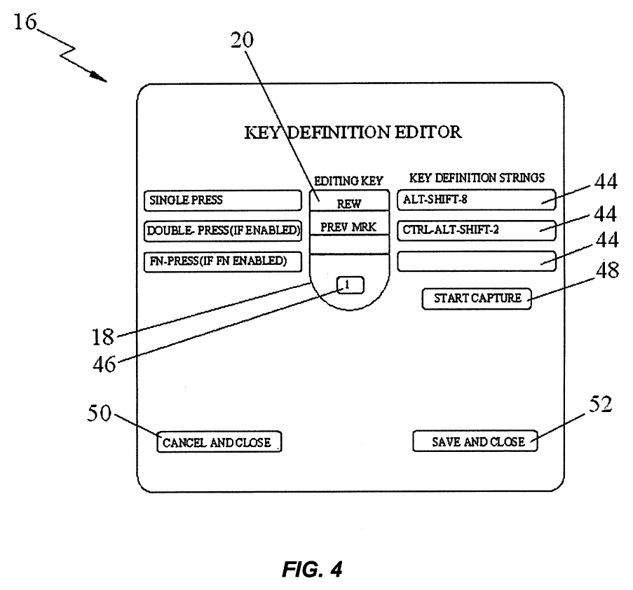

Referring to FIG. 4, the editor window 16 is opened when functional name fields 20 of any one of the eight key cap links 18 is clicked. The key function editor window 16 comprises the corresponding key cap link with the three functional name fields 20 and three key definition string fields 44. The number of the key cap link 18 can be edited in the key number field 46. Users can assign and edit the names of the functions in the functional name fields.

Users can also view or edit underlying character strings assigned for each function in the key definition string fields 44. New character strings can be edited or added by typing a character string into the key definition string field 44. The key function editor window 16 further comprises a ‘capture’ button 48, which provides an alternative to typing the character string. When the ‘capture’ button 48 is activated, the program records the keystrokes typed by the user.

The key function editor window 16 further comprises a ‘cancel and close’ button 50 and a ‘save and close’ button 52. The clicking of ‘cancel and close’ button 50 causes the application to be closed without saving any changes made to the key function editor window 16. The application is closed after saving the changes made to the key function editor window 16 as a consequence of clicking of the ‘save and close’ button 52.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, paragraph 6. In particular, the use of “step of” in the claims herein is not intended to invoke the provisions of 35 U.S.C. §112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A foot-operated programmable transport controller for use in digital audio workstations; the controller for use in conjunction with a music and sound-editing software application while connecting a musical instrument, the controller comprising:
(a) a keyboard comprising a plurality of keys, each key for performing at least one function pertaining to the software application; and
(b) a user interface for creating, editing, storing, and retrieving different profiles, the profile being a complete set of all functions assigned to all the keys and their combinations; the user interface provided through a host computer system.

2. The controller of claim 1 providing a collection of different default profiles on a CD or a DVD, accessible through the host computer system.

3. The controller of claim 1, wherein the keyboard can be configured through the user interface such that pressing any key once can produce a functional effect on the software application; the event of pressing the key once referred as a single press.

4. The controller of claim 3, wherein the single press is assigned with a function pertaining to the software application through the user interface.

5. The controller of claim 1, wherein the keyboard can be enabled through the user interface such that pressing a key twice in succession can produce a functional effect on the software application; the event of pressing a key twice in succession referred as a double press.

6. The controller of claim 5, wherein the double press is assigned with a function pertaining to the software application through the user interface.

7. The controller of claim 5 providing a means for adjusting the time sensitivity of the double press through the user interface.

8. The controller of claim 1, wherein the plurality of keys comprises a function key, which when activated through the user interface, can be used in combination with any other key so as to produce a functional effect on the software application; the event of pressing a function key in combination with anyone of the rest of the keys referred as function press.

9. The controller of claim 8, wherein the function-press comprises pressing of the function key followed by the pressing of anyone of the plurality of keys.

10. The controller of claim 9, wherein the function-press can be assigned with a function pertaining to the software application through the user interface.

11. The controller of claim 10, wherein when the function key is activated, all the keys except the function key respond to three key-press events, viz., single press, double press, and function press, each event can be assigned with a function pertaining to the software application; the single press, double press, and function press events defined by the pressing of the key once, pressing of the key twice in succession, and pressing of the function key followed by the pressing of anyone of the other keys respectively.

12. The controller of claim 11, wherein when the function key is active, it can only be used in combination with another key for producing the functional effect.

13. The controller of claim 8, wherein the function key operates as any other key when inactive.

14. The controller of claim 13, wherein when the function key is inactive, all the keys respond to two key-press events, viz., single press and double press, each event can be assigned with a function pertaining to the software application; the single and double press events defined by the pressing of the key once and the pressing of the key twice in succession respectively.

15. The controller of claim 1, wherein the keys are ergonomically designed to be pressed by the foot of a user.

16. The controller of claim 1, wherein the keyboard comprises eight keys.

17. The controller of claim 1, wherein the keyboard resembles a stepped structure, the keys are disposed on the keyboard such that half of them are disposed on the upper step and the rest are disposed on the lower step.

18. The controller of claim 17, wherein the keys on each step are spaced apart.

19. The controller of claim 1, wherein the keyboard is connected to the computer system through a wireless Universal Serial Bus (USB) connection.

20. The controller of claim 1, wherein the keyboard is battery operated.

21. The controller of claim 1, wherein the keyboard further comprises a Printed Circuit Board (PCB), a wireless USB adapter that can be plugged into a USB port on the computer system.

22. The controller of claim 21, wherein the PCB comprises a processor, a non-volatile memory, and a programmable firmware memory.

23. The controller of claim 1, wherein the keyboard further comprises an automatic low-power standby mode, a low-battery Light Emitting Diode (LED) indicator, a low wireless signal strength LED indicator, and an activity LED monitor that activates when any key is pressed.

24. The controller of claim 1, wherein the keyboard holds one profile at a time.

25. The controller of claim 1, wherein the user interface comprises a main utility window comprising plurality of key cap links, each key cap link representing a key on the keyboard and displaying function/functions assigned to the same.

26. The controller of claim 25, wherein each key cap link guides a user to its corresponding key function/definition editor window when clicked thereon, the key function/definition editor window allows the user to make changes to the current configuration of that key cap link thus affecting the corresponding key functions automatically; the main utility window providing a means for saving the changes thus made.

27. The controller of claim 26, wherein each key function/definition editor window comprises a means for assigning the keys or a combination of keys of a conventional computer keyboard for each of its functions for operating the software application alternatively.

28. The controller of claim 25, wherein the main utility window further comprises a means for retrieving and loading previously saved profiles from the host computer system.

29. The controller of claim 25, wherein the main utility window further comprising a means for displaying path of the current profile.
